(19) United States
(12) Patent Application Publication
(10) Pub. No.: US 2017/0010948 A1
(43) Pub. Date: Jan. 12, 2017

(54) MONITORING A COMPUTING ENVIRONMENT

(71) Applicant: HEWLETT PACKARD ENTERPRISE DEVELOPMENT LP, Houston, TX (US)

(72) Inventors: Amit Kumar, Bangalore (IN); Sultan Raja, Bangalore (IN); Balagurunathan Rajagopal, Bangalore (IN)

(21) Appl. No.: 15/117,869

(22) PCT Filed: Feb. 12, 2014
(86) PCT No.: PCT/US2014/015978

§ 371 Date: Aug. 10, 2016

(51) Int. Cl. G06F 11/34; G06F 11/30

(52) U.S. Cl. CPC G06F 11/3409; G06F 11/3093; G06F 11/3051; G06F 2201/86

(57) ABSTRACT

Monitoring a computing environment can include monitoring configuration attributes, performance metrics, and event indicators of a configuration item (CI). Monitoring a computing environment can include determine a monitoring level for the CIs by applying a number of rules that define monitoring levels based on the configuration attributes, performance metrics, and event indicators of the CI.

### BACKGROUND

Performance needs of information technology (IT) infrastructure vary based on business needs, such as uptime, load, and/or scale, for example. Administrators can use their knowledge of an application environment to provide intervention to ensure that the application environment is meeting performance needs. Due to the variance in application and system environments, the monitoring needs of the various application and system environments differ. The different monitoring needs of the various application and system environments can be determined by an administrator that can monitor the performance of an application and/or system and determine how the application and/or system should be monitored.

### BRIEF DESCRIPTION OF THE DRAWINGS

FIG. 1 illustrates a diagram of an example of a system for monitoring a computing environment according to the present disclosure.

FIG. 2 illustrates an example of a system according to the present disclosure.

FIG. 3 illustrates a diagram of an example of an environment for monitoring a computing environment according to the present disclosure.

FIG. 4 illustrates an example of a method for monitoring a computing environment according to the present disclosure.

### DETAILED DESCRIPTION

IT infrastructures with various application and system environments, the monitoring needs for each of the various application and system environments differ. The present disclosure includes methods and systems for monitoring a computing environment. According the present disclosure, the monitoring of a computing environment can be automatically and dynamically updated based on configuration attributes, performance metrics, and event indicators of configuration items in the computing environment. For example, configuration attributes, performance metrics, and event indicators of configuration items in the computing environment are monitored and recorded and then rules are applied to those configuration attributes, performance metrics, and event indicators to determine a monitoring level for the configuration items.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an element and/or feature can refer to one or more of such elements and/or features.

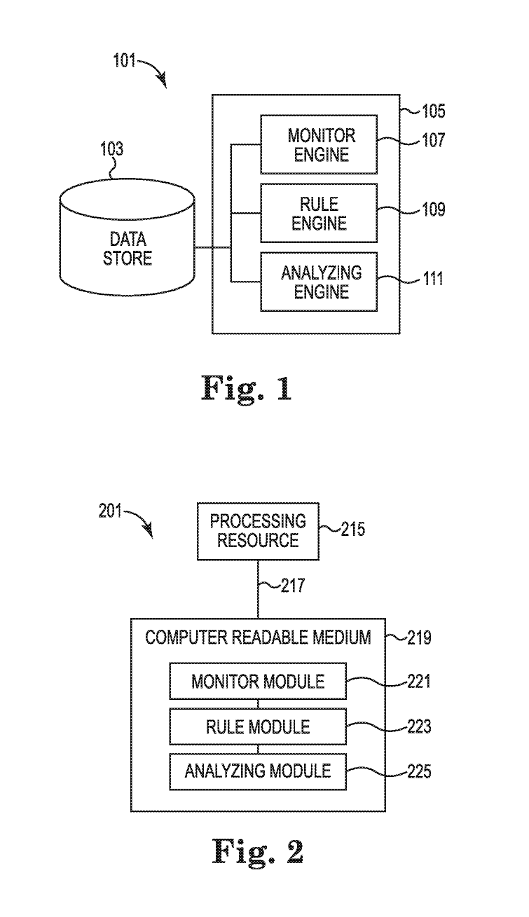

FIG. 1 illustrates a diagram of an example of a system 101 for monitoring a computing environment according to the present disclosure. The system 101 can include a data store 103, resource management system 105, and/or a number of engines 107, 109, and 111. The resource management system 105 can be in communication with the data store 103 via a communication link, and can include the number of engines (e.g., monitor engine 107, rule engine 109, and analysis engine 111). The resource management system 105 can include additional or fewer engines than illustrated to perform the various functions described herein.

The number of engines 107, 109, and 111 can include a combination of hardware and programming that is configured to perform a number of functions described herein (e.g., determine a monitoring level for a configuration item (CI)). The programing can include program instructions (e.g., software, firmware, etc.) stored in a memory resource (e.g., computer readable medium, machine readable medium, etc.) as well as hard-wired program (e.g., logic).

A monitor engine 107 can include hardware and/or a combination of hardware and programming to monitor configuration items (CIs) in an application stack. For example, configuration attributes, performance metrics, and event indicators of configuration items in a computing environment can be monitored by the monitor engine 107. The monitor engine 107 can monitoring various components of a computing environment, such as applications, infrastructure, and/or network interfaces, for example, among other components. The monitor engine 107 can run a monitoring solution such as a business service management (BSM) application, for example. The monitor engine 107 can be associated with a configuration management database (CMDB) of the computing environment.

The monitor engine 107 can monitor events associated with CIs. The monitor engine 107 can monitor events associated with CIs to determine event indicator information. Event indicator information can include information that identifies the type of event, the timing of the event, and/or other information used to identify the event. Event indicator information can also include the event state information. Event state information can include error information, availability information, and/or performance information for a CI.

The monitor engine 107 can monitor configuration attributes and performance metrics of a CI. The monitor engine 107 can monitor a CI to determine its current configuration and those configuration attributes can be stored in a repository. The configuration attributes of a CI can include information such as replication state and type, an amount of memory allocated to the CI, and a user capacity of the CI, for example. Also, the monitor engine 107 can monitor performance metrics of a CI. The performance metrics of a CI that are monitored can include a transaction rate and/or a query performance metric, for example, among other performance metrics.

A rule engine 109 can include hardware and/or a combination of hardware and programming to create, modify, and/or enable/disable rules that define monitoring levels of configuration items in a computing environment. The rules that define the monitoring levels of configuration items in a computing environment can be based on the configuration attributes, performance metrics, and event indicators monitored by the monitor engine 107. The rules engine 109 can define a monitoring level that will be used for a configuration items (CIs) with certain characteristics based on the information from the monitor engine 107. The rules in rules engine 109 can be created, modified, enabled, and/or disabled by an administrator or by implementing commands that create, modify, enable, or disable rules.

An analysis engine 111 can include hardware and/or a combination of hardware and programming to determine monitoring levels for configuration items of a computing environment. The analysis engine 111 can apply the rules from the rule engine 109 to the configuration attributes, performance metrics, and event indicators monitored by the monitor engine 107 to determine a monitoring level for the configuration items of a computing environment. Monitoring levels for configuration items determined by the analysis engine 111 can be applied to the computing environment and implemented by the monitor engine 107. The information gathered using monitoring levels implemented by the monitor engine 107 based on determinations of the analysis engine 111 can, in turn, be used by the analysis engine 111 to make additional determinations that may or may not change a monitoring level for a CI.

FIG. 2 illustrates an example of a system 201 according to the present disclosure. The system 201 can utilize software, hardware, firmware, and/or logic to perform a number of functions described herein. The system 201 can be any combination of hardware and program instructions configured to share information. The hardware, for example can include a processing resource 215 and/or a computer-readable medium 219 (e.g., machine readable medium (MRM), database, etc.). A processing resource 215, as used herein, can include any number of processors capable of executing instructions stored by a computer-readable medium 219. Processing resource 215 may be integrated in a single device or distributed across multiple devices. The program instructions (e.g., computer-readable instructions (CRI)) can include instructions stored on the computer-readable medium 219 and executable by the processing resource 215 to implement a desired function (e.g., convert a hybrid flow to a data flow graph).

The computer-readable medium 219 can be in communication with a processing resource 215. A computer-readable medium 219, as used herein, can include any number of memory components capable of storing instructions that can be executed by processing resource 215. Such computer-readable medium 219 can be a non-transitory CRM or MRM. Computer-readable medium may be integrated in a single device or distributed across multiple devices. Further, computer-readable medium 219 may be fully or partially integrated in the same device as processing resource 215 or it may be separate but accessible to that device and processing resource 215. Thus, it is noted that the system 201 may be implemented on a participant device, on a server device, on a collection of server devices, and/or a combination of the user device and the server device.

The computer-readable medium 219 can be in communication with the processing resource 215 via a communication link (e.g., a path) 217. The communication link 217 can be local or remote to a machine (e.g., a computing device) associated with the processing resource 215. Examples of a local communication link 217 can include an electronic bus internal to a machine (e.g., a computing device) where the computer-readable medium 219 is one of volatile, non-volatile, fixed, and/or removable storage medium in communication with the processing resource 215 via the electronic bus.

A number of modules 221, 223, and 225 can include CRI that when executed by the processing resource 215 can perform a number of functions. The number of modules 221, 223, and 225 can be sub-modules of other modules. For example, the monitor module 221 and the rule module 223 can be sub-modules and/or contained within the same computing device. In another example, the number of modules 221, 223, and 225 can comprise individual modules at separate and distinct locations (e.g., CRM, etc.).

Each of the number of modules 221, 223, and 225 can include instructions that when executed by the processing resource 215 can function as a corresponding engine as described herein. For example, monitor module 221 can include instructions that when executed by the processing resource 215 can function as the monitor engine 107. In another example, the rule module 223 can include instructions that when executed by the processing resource 215 can function as the rule engine 109.

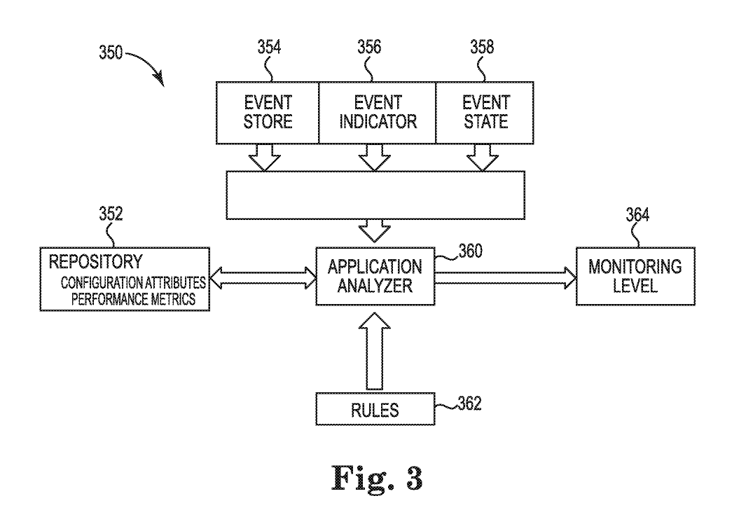

FIG. 3 illustrates a diagram of an example of an environment 350 for monitoring a computing environment according to the present disclosure. A computing environment can include a number of computing devices coupled together via a network that are running an application stack. The application stack can include a number of applications. The computing environment can include a configuration management database (CMDB) that is used to track the configuration of each of the configuration items (CIs) in the computing environment. The number of applications can include various configuration items (CIs) that are monitored using a monitoring application, such as a business service management (BSM) application. The environment 350 that includes a monitoring application can monitor various configuration attributes, performance metrics, and event indicators of the configuration items.

The monitoring application of the environment 350 can monitor events associated with CIs. The events can include associated information that is monitored using the monitoring application. The information associated with an event can include an event store 354, an event indicator 356, and an event state 358. The event store 354 can be a location that logs and stores information associated with a CI event. The event store 354 can include an event indicator 356 and an event state 358. The event indicator 356 can include information that identifies the type of event, the timing of the event, and/or other information used to identify the event. The event indicator 356 can also include the event state 358. The event state 358 can include information about the current state of a CI. For example, the event state 358 can include error information, availability information, and/or performance information for a CI. The event store 354, event indicator 356, and event state 358 can be part of a content packet that is monitored using a monitoring application, such as an operations manager, for example. The event indicator 356 information, which can include the event state 358, in the event store 356 can be used to determine monitoring levels for CIs.

The monitoring application of the environment 350 can monitor configuration attributes and performance metrics of a CI and store them in a repository 352. The monitoring application of environment 350 can monitor a CI to determine its current configuration and store those configuration attributes in the repository 352. The configuration attributes of a CI can include information such as replication state and type, an amount of memory allocated to the CI, and a user capacity of the CI, for example. Also, the monitoring application of environment 350 can monitor performance metrics of a CI and store them in the repository 352. The performance metrics of a CI that are monitored can include a transaction rate and/or a query performance metric, for example, among other performance metrics. The repository 352 can include memory to store the configuration attributes and performance metrics of CIs. The configuration attributes and performance metrics of CIs store in repository 352 can be used to determine monitoring levels for CIs.

The monitoring application of the environment 350 can include a number of rules 362 that are applied to the information associated with CI found in the event store 354 and the repository 352. Rules 362 can include rules that define a monitoring level for CIs based on the configuration attributes, performance metrics, and/or event indicators of a CI. The rules 362 can define a type of monitoring for a CI and the level at which the monitoring will be performed. For example, the rules 362 can define that the monitoring type, e.g., monitoring aspect, for a CI will be streams monitoring, Oracle Query Performance monitoring, and/or Oracle IO Performance monitoring, for example, among other type of monitoring. Also, for example, the rules 362 can define the level of monitoring, e.g., aspect level, for a CI, such as Level 1, Level 2, and/or Level 3 monitoring, where the monitoring levels can include various frequencies of monitoring data of a CI and/or various amounts of data associated of a CI that is monitored. The rules 362 can define monitoring levels for a CI based on configuration attributes of a CI, performance metrics of a CI, and/or event indicators of a CI.

The rules 362 can define monitoring levels based on a type of CI that is indicated by the configuration attributes stored in repository 352. For example, a rule may state that if the configuration attribute of a CI is that the replication state of the CI is TRUE and the replication type of a CI is streams, then the monitoring level for the CI includes using stream monitoring at Level 1. The rules 362 can define monitoring levels based on thresholds associated with the performance metrics of a CI stored in repository 352. For example, if the transaction rate of a CI is less than 500 transactions per second, the monitoring level for the CI includes using Oracle Query Performance monitoring at Level 1. The rules 362 can define monitoring levels based on event indicators 356 in event store 354. For example, a rule may state that if the event indicator of a CI is that the state of the CI is “ApplyError”, then the monitoring level for the CI includes using stream monitoring at Level 2.

The rules 362 can be modified to change the basis for determining monitoring levels of CIs, new rules can be added to define monitoring levels of CIs, and/or rules can be enabled or disabled, so that the rules may or may not be applied to determine monitoring levels of CIs. In a number of examples, each aspect of a CI may have a rule associated with that aspect, so that each aspect of CI may have different monitoring levels.

Environment 350 can includes an application analyzer 360 that can apply the rules 362 to the configuration attributes and performance metrics of CIs in repository 352 and the event indicators 356 of CI in event store 354 to determine a monitoring level 364 for CIs. The application analyzer 360 can instruct the environment 350 to monitor CIs using the monitoring level 364 determined by the application analyzer 360. The monitoring level 364 that the environment 350 uses to monitor CIs can be periodically or continuously updated by the application analyzer 360.

In a number of examples, a monitoring application can monitor a number of configuration items in a computing environment. The monitoring application can determine that a CI has certain configuration attributes, such as the amount of memory allocated to the CI is 200 MB and the maximum user capacity is 150 users, for example. The monitoring application can determine that a CI has certain performance metrics, such as the transaction rate for the CI is 200 transactions per second, for example. Based on these characteristics determined by a monitoring application, an application analyzer can apply a rule that defines a monitoring level for the CI. For example, a rule can be included that defines using stream monitoring at Level 2 when the amount of memory allocated to a CI is greater than 100 MB and the transaction rate of a CI is greater than 150 transactions per second, therefore the application analyzer can apply the rule to information determined by the monitoring application to determine that a monitoring level that includes using stream monitoring at Level 2 should be applied to the CI. The application analyzer provides instructions to the monitoring application to monitor the CI using stream monitoring at Level 2.

In a number of examples, a monitoring application can monitor a number of configuration items in a computing environment. The monitoring application can determine information associated with events of a CI, such as the Oracle transaction status of a CI is failure, for example. Based on information associated with an event of a CI as determined by a monitoring application, an application analyzer can apply a rule that defines a monitoring level for the CI. For example, a rule can be included that defines using Oracle IO monitoring at Level 3 when the Oracle transaction status of a CI is failure, therefore the application analyzer can apply the rule to information determined by the monitoring application to determine that a monitoring level that includes using Oracle IO monitoring at Level 3 should be applied to the CI. The application analyzer provides instructions to the monitoring application to monitor the CI using Oracle IO monitoring at Level 3.

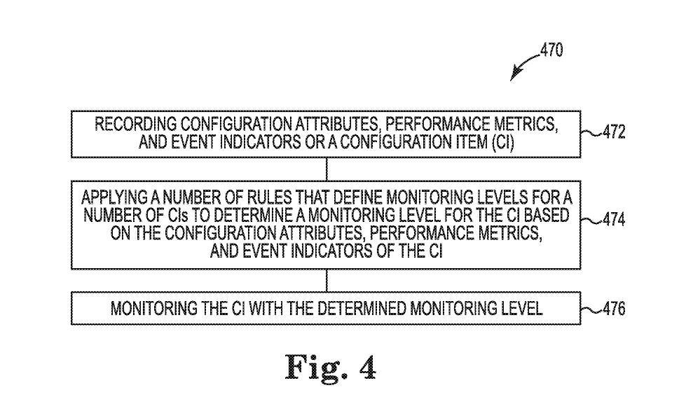

FIG. 4 illustrates an example of a method 470 for monitoring a computing environment according to the present disclosure. At 472, the method 470 can include recording configuration attributes, performance metrics, and/or event indicators of a configuration item (CI). The configuration attributes, performance metrics, and/or event indicators of a CI can be determined using a monitoring application. The configuration attributes and performance metrics of a configuration item (CI) can be stored and recorded in a repository. The event indicators of a configuration item (CI) can be stored and recorded in an event store. For example, a default monitoring level can be used to initially gather and record the configuration attributes, performance metrics, and/or event indicators of a CI. The configuration attributes, performance metrics, and/or event indicators of a CI can be used by an application analyzer to help determine the monitoring level for the CI.

At 474, the method 470 can include applying a number of rules that define monitoring levels for a number of CIs to determine a monitoring level for the CI based on the configuration attributes, performance metrics, and event indicators of the CI. The number of rules can be applied using an application analyzer. The application analyzer can instruct a monitoring application to monitor CIs using the monitoring level determined by the application analyzer. In a number of examples, the rules that are applied by the application analyzer can be determined by selecting a view of a CI from a user interface and then selecting the rules that will be applied to that CI. As discussed above, the rules define a monitoring level for CIs based on the configuration attributes, performance metrics, and/or event indicators of a CI.

At 476, the method 470 can include monitoring the CI with determined monitoring level. The CI can be monitored with determined monitoring level and this monitoring level can provide additional configuration attributes, performance metrics, and/or event indicators of the CI so that the monitoring level of the CI can be updated periodically or continuously.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A system to monitor a computing environment, comprising a processing resource in communication with a non-transitory machine readable medium having instructions executed by the processing resource to implement:
a monitor engine to monitor a number of configuration items (CIs) for configuration attributes, performance metrics, and event indicators;
a rule engine to provide a number of rules that define monitoring levels for the number of configuration items (CIs); and
an analysis engine to analyze the configuration attributes, performance metrics, and event indicators of each of a number of CIs to determine a monitoring level for each of the number of CIs based on the number of rules.

2. The system of claim 1, wherein the monitor engine monitors each of the number of CIs using the determined monitoring level for each of the number of CIs

3. The system of claim 1, wherein the monitoring level includes a type of monitoring to perform.

4. The system of claim 1, wherein the number of rules define monitoring levels for the number of CIs based on configuration attributes, performance metrics, and event indicators.

5. The system of claim 1, wherein analysis engine applies the number of rules to the configuration attributes, performance metrics, and event indicators to determine the monitoring level for each of the number of CIs.

6. The system of claim 1, wherein the monitor engine monitors the event indicators using an operations manager.

7. A non-transitory machine-readable medium storing instructions executable by a processing resource to:
record configuration attributes, performance metrics, and event indicators for a configuration item (CI); and
determine a monitoring level for the CIs by applying a number of rules that define monitoring levels based on the configuration attributes, performance metrics, and event indicators of configuration items (CIs).

8. The medium of claim 7, wherein configuration attributes and performance metrics for the CI is stored in a repository.

9. The medium of claim 7, wherein the medium includes instructions executable by a processing resource to determine the monitoring level for the CI when there is a change in the configuration attributes, performance metrics, or event indicators for the CI.

10. The medium of claim 7, wherein each of the number of monitoring levels includes a type of monitoring to perform on the CI.

11. The medium of claim 7, wherein the medium includes instructions executable by a processing resource to monitor an application stack that includes the CI using the determined monitoring level.

12. The medium of claim 7, wherein event indicators for the CI are stored in an event store.

13. A method for monitoring a computing environment, comprising:
recording, by a processor, configuration attributes, performance metrics, and event indicators of a configuration item (CI);
applying, by the processor, a number of rules that define monitoring levels for a number of CIs to determine a monitoring level for the CI based on the configuration attributes, performance metrics, and event indicators of the CI; and
monitoring, by the processor, the CI with the determined monitoring level.

14. The method of claim 13, comprising monitoring configuration attributes, performance metrics, and event indicators of the CI.

15. The method of claim 13, comprising monitoring a transaction rate of the CI.
